(19) United States
(12) Patent Application Publication
(10) Pub. No.: US 2009/0080963 A1
(43) Pub. Date: Mar. 26, 2009

(54) Propel/repel dispensers

(75) Inventors: James Skakoon, St. Paul, MN (US); Kevin S. Fuller, Centerville, MN (US); Greg J. Benson, Cokato, MN (US)

Correspondence Address: Breiner & Breiner, L.L.C., P.O. Box 320160, Alexandria, VA, 22320-0160, US

(73) Assignee: Federal Package Network, Inc., Chaska, MN (US)

(21) Appl. No.: 12/289,217

(22) Filed: Oct. 23, 2008

Related U.S. Application Data
(62) Division of application No. 11/181,786, filed on Jul. 15, 2005.
(60) Provisional application No. 60/588,767, filed on Jul. 19, 2004.

(51) Int. Cl. B43K 21/08

(52) U.S. Cl. 401/175

(57) ABSTRACT

A propel/repel dispenser having one or more features in combination to provide improved manufacture, assembly and use of the dispenser. Such features include a wide single lead thread, a “click” feature to provide sound and feel to a user so that propelling and repelling can be controlled, and a retention element involving a single slot extending from a central opening through which a screw structure passes upon assembly of the dispenser.

### RELATED APPLICATIONS

This application is a division of Ser. No. 11/181,786 filed Jul. 15, 2005, which claims the benefit under 35 U.S.C. § 119(e) of U.S. Provisional Application Ser. No. 60/588,767, filed Jul. 19, 2004, entitled PROPEL/REPEL DISPENSERS.

### FIELD OF INVENTION

The invention is directed to propel/repel dispensers, in particular containing one or a combination of features providing for improved manufacture, assembly and consumer use. Inventive features disclosed include a single lead thread for the internal screw structure, a “click” feature which provides sound and feel to a consumer to indicate advance of the product in the dispenser upon propelling or repelling, and a single slot retention means for holding the screw structure in place in a dispenser body upon assembly.

### BACKGROUND OF THE INVENTION

Stick applicators having various dispensing structures are generally known as being useful for dispensing various products including lip balms, lipsticks, deodorants, and the like. Stick applicators may take the form of, for example, a roll-on applicator for a liquid or a screw-operated push-up applicator for a non-liquid substance.

In a typical screw operated push-up applicator, material is stored within a barrel or body and is supported by an internally threaded elevator. A rotatable dispensing screw extends longitudinally inside the barrel and engages the elevator. The screw has a control knob, located at a non-dispensing end of the barrel, that determines the elevator's position. When the knob is turned, the screw is rotated inside the barrel causing the elevator to travel longitudinally, and push the material out of an opposite (dispensing) end of the barrel.

A screw-operated push-up applicator may also have a control knob which is non-rotatably fixed within an outer container surrounding a barrel, such that upon turning the barrel itself by a collar on the opposite end has the effect of moving the elevator within the barrel. This structure is described in U.S. Pat. No. 5,842,802.

In the general operation of a typical screw operated push-up applicator, a user turns the control knob causing the threaded shaft of the screw to turn, and thereby cause the elevator to travel inside the barrel with concomitant movement of the product up or down from the dispensing end of the barrel. The amount of product dispensed from or retracted into the barrel is proportionate to the extent to which the control knob is turned.

Deficiencies in existing stick applicators make them less than optimal in use. First, the amount of product dispensed is difficult to control because it is indiscriminately dispensed when the control knob is turned. Special care and attention are required to position the control knob so that a precise desired amount of product is exposed or dispensed. If too much of the product is extended, the stick can break. If too little is extended, inadequate application of the product results or repeated application is required. Second, accidental dispensing can be a problem with existing stick applicators. Since there is no stop or check on the control knob, it is easily turned by various types of unintended contact.

Various screw operated applicators are known in the art as described for example in U.S. Pat. No. 3,917,417 and U.S. Pat. No. 1,950,324. They are useful for dispensing such products as lip balms, deodorants, lubricants and the like. While other stick applicator, structures are known which provide for incremental dispensing, such structures are complex requiring multiple components of interrelating structures. This is expensive in terms of materials, time, and labor in assembly during the manufacturing process for dispensing lipstick from the holder.

It would be advantageous to have a screw operated stick applicator that avoids accidental dispensing of product and that allows a user to quickly and easily dispense convenient predetermined amounts of product incrementally and without resorting to careful fine tuning of the control knob, in particular which does not require complex and expensive dispensing structures, and provides an indication to the consumer of the advance of the product in the dispenser upon propelling or repelling.

### SUMMARY OF INVENTION

Propel/repel containers include a dispensing body, a central screw structure including a lengthwise extending screw threaded upright member and a turn screw at a base thereof, an elevator which travels along the screw thread of the upright member to propel or repel product contained within the dispenser body, and a cap for sealing the product in the dispenser during non-use.

Conventional thread designs for screws and elevators of propel/repel dispensers consist of double, triple or quadruple lead 6 or 8 pitch threads that require complicated high maintenance unscrewing molds for the elevators having internal threads and complicated molds for the screws having external threads with only half threads because of undercuts. The screw structure and elevator of the invention provide for a wide single lead thread. The internal thread of the elevator is one complete revolution which is molded without unscrewing or “popping off.” This is accomplished by telescoping two half core pins to meet and form two halves of the thread. The result is a very strong and complete thread that is easier to tool, mold, and maintain without compromising the integrity of the function of thread and, in fact, provides an improved thread structure. The external thread of the screw structure is a matching single lead wide thread. This structure renders a parting line undercut insignificant and allows for the tooling and molding of a complete round thread. “Wide” in reference to the screw thread refers to the thread profile detail being based on evenly spacing the root and crest over a major length of the screw based on the “threads per inch.” For example, a 6 threads per inch would result in a wider spaced root and crest than an 8 threads per inch, i.e., 0.075 vs. 0.055 respectively. Preferably, the wide single lead thread has from about 4 to about 10 threads per inch, more preferably from about 5 to about 9 threads per inch, and most preferably from about 6 to about 8 threads per inch.

A further feature of the invention is to provide a “click” feature in the dispenser which provides a sound and feel to a consumer upon propelling or repelling product within the dispenser. The “click” feature is provided by a screw trigger which involves at least one, preferably two, main extensions or flaps projecting outward from the screw structure in the lower part of the screw structure above the turn screw, and at least one, preferably a plurality of, mating rib(s) extending inward from a wall surface of the dispenser body, preferably the base wall of the dispenser body. The mating ribs are structured to provide a predetermined amount of pressure and response and are placed in alternate contact between the extension(s) or flap(s) of the “click” feature. Upon rotation of the turn screw to propel or repel the elevator on the screw to dispense or retract product, a consumer will hear, as well as feel, a “click” upon the interaction of the extension(s) or flap(s) with the mating rib(s). Such provides a control for the amount of product dispensed or retracted. Preferably two extensions are used with a plurality of ribs, e.g., 7, so as to provide smaller increments upon which a click is heard and felt. This provides for a greater control of the amount of the product propelled or repelled.

Another feature of the invention is a screw retention means. Conventional screw retention means are either solid conical structures or multi-segmented structures within the bottom wall of the dispenser body. The retention means of the invention comprises a single slot positioned opposite a gate location in the bottom or base wall of the dispenser body through which the screw structure extends. The single slot provides for flexibility during assembly of the screw in the dispenser body while also maintaining strength to retain the screw in the dispenser body. Situating the single slot opposite the gate optimizes the structure based on the flow of plastic during molding of the dispenser body.

A primary object of the invention is to provide a propel/repel dispenser having a single lead thread on an internal screw structure.

Another primary object of the invention is to provide a propel/repel dispenser having a “click” feature which provides sound and feel to a consumer to indicate advance of a product in the dispenser upon propelling or repelling.

Another primary object of the invention is to provide a propel/repel dispenser having a single slot retention means for holding a screw structure in place in a dispenser body upon assembly.

These primary and other objects of the invention will be apparent from the following description of the preferred embodiments of the invention and from the accompanying drawings.

### BRIEF DESCRIPTION OF DRAWINGS

FIG. 1 is a perspective view of a first embodiment of the screw structure with a central upright member with a single lead screw thread of the invention and a turn screw at the base thereof.

FIG. 2 is a side view of the first embodiment of the screw structure of FIG. 1.

FIG. 3 is a top view of the screw structure as shown in FIG. 2.

FIG. 4 is a cross-section along line 4-4 of FIG. 3.

FIG. 5 is a perspective view of a second embodiment of the screw structure of the invention including the single lead thread on the central upright member and including two extensions or flaps projecting outward of the central upright member above the turn screw, wherein the two extensions are a first part of the “click” feature of the invention.

FIG. 6 is a top view of the screw structure of FIG. 5.

FIG. 7 is a cross-section of the screw structure of the invention taken along line 7-7 of FIG. 6.

FIG. 8 is a side view of the second embodiment shown in FIG. 5 showing two extensions of the “click” feature from the side.

FIG. 9 is a side view of the screw structure of FIG. 8 turned 90° to show an extension of the “click” feature from an end view of the extension.

FIG. 10 is a perspective view of a third embodiment of the screw structure of the invention including a single lead thread on the central upright member and a turn screw at the base thereof.

FIG. 11 is a side view of the third embodiment of the screw structure shown in FIG. 10.

FIG. 12 is a top view of the screw structure as shown in FIG. 10.

FIG. 13 is a cross-section of the screw structure of the invention taken along line 13-13 of FIG. 12.

FIG. 14 is a detail of the circled section of FIG. 11 showing a widened portion of the screw structure.

FIG. 15 is a cross-section of the screw structure of the invention taken along the line 15-15 of FIG. 11.

FIG. 16 is a cross-section of the screw structure of the invention taken along the line 16-16 of FIG. 11.

FIG. 17 is a side view of a fourth embodiment of the screw structure of the invention including a single lead thread on the central upright member and including two extensions projecting outward of the central upright member above the turn screw, wherein the two extensions are a first part of the “click” feature of the invention.

FIG. 18 is a top view of the screw structure of FIG. 17.

FIG. 19 is a cross-section of the screw structure of the invention taken along line 19-19 of FIG. 18.

FIG. 20 is a cross-section of the screw structure taken along the line 20-20 of FIG. 17.

FIG. 21 is a detail of the circled section of FIG. 17 showing a widened portion of the screw structure.

FIG. 22 is an exterior front view of the body of the dispenser with phantom lines showing internal structures, including a second part of the “click” feature comprising a plurality of ribs extending inward from an interior wall of the body.

FIG. 23 is a cross-section along line 23-23 of FIG. 22.

FIG. 24 is an external side view of the body of the dispenser of FIG. 22.

FIG. 25 is a cross-section along line 25-25 of FIG. 24.

FIG. 26 is a detail showing a bottom view of a single rib of the second part of the “click” feature.

FIG. 27 is a detail of the circled section of FIG. 25 showing a rib of the “click” feature.

FIG. 28 is a bottom view of the body of the dispenser showing a single slot extending off a central opening in the base wall of the body in accordance with the invention, the base wall in conjunction with a retaining means on the screw structure holding the screw structure in place within the body upon assembly.

FIG. 29 is a perspective view of a first embodiment of an elevator configured for movement along the screw thread of the invention within an elliptical body of the dispenser.

FIG. 30 is a top perspective view of the elevator of FIG. 29.

FIG. 31 is a bottom perspective view of the elevator of FIG. 29.

FIG. 32 is a front view of the exterior of the elevator of FIG. 29 with phantom lines showing internal structural features.

FIG. 33 is a cross-sectional side view taken along line-33-33 of FIG. 32 showing an internal screw thread which complements the external screw threads of the screw structure of the invention.

FIG. 34 is a side view of the exterior of the elevator of FIG. 29 showing internal structures.

FIG. 35 is a cross-sectional view along line 35-35 of FIG. 34.

FIG. 36 is a detail of a rib within the circle of FIG. 33.

FIG. 37 is a detail of a top rim of the elevator within the circle portion of FIG. 35.

FIG. 38 is a first embodiment of a lead screw thread of the screw structure of the invention.

FIG. 39 is a top perspective view of a second embodiment of an elevator configured for movement along the screw thread of the invention within an elliptical body of the dispenser.

FIG. 40 is a bottom perspective view of the elevator of FIG. 39.

FIG. 41 is a side view of the exterior structure of the elevator of FIG. 39 showing internal structures.

FIG. 42 is a cross-sectional view along line 42-42 of FIG. 41.

FIG. 43 is a second embodiment of a lead screw thread of the screw structure of the invention.

FIG. 44 is a bottom perspective view of a third embodiment of an elevator of the invention configured for use in a round dispenser body.

FIG. 45 is a top perspective view of the elevator of FIG. 44.

FIG. 46 is a bottom view of the elevator of FIG. 44.

FIG. 47 is a cross-sectional view along line 47-47 of FIG. 46.

FIG. 48 is a cross-sectional view along line 48-48 of FIG. 46.

FIG. 49 is a bottom perspective view of a fourth embodiment of an elevator of the invention configured for use in a round dispenser body.

FIG. 50 is a top perspective view of the elevator of FIG. 49.

FIG. 51 is a bottom view of the elevator of FIG. 49.

FIG. 52 is a cross-sectional view along line 52-52 of FIG. 51.

FIG. 53 is a cross-sectional view along line 53-53 of FIG. 51.

FIG. 54 is a detail of a rib within the circle portion of FIG. 53.

FIG. 55 is a perspective view of an assembled elliptical-shaped dispenser of the invention.

FIG. 56 is a side view of the dispenser of FIG. 55 showing direction of assembly of the screw structure and cap on the dispenser body (the elevator is not shown).

FIG. 57 is a perspective top view of a cap for attachment to the elliptical body of the dispenser.

FIG. 58 is a cross-sectional view of the cap along line 58-58 of FIG. 57.

FIG. 59 is a cross-sectional front view of an assembled dispenser including a body, a screw structure with a single lead thread and two extensions of the “click” feature, an elevator with internal screw threads which complement the external screw threads on the upright member of the screw structure, and a cap.

FIG. 60 is a cross-sectional side view of the assembled dispenser as shown from the front in FIG. 59 wherein ribs of the “click” feature are shown.

### DETAILED DESCRIPTION OF THE INVENTION

The invention is directed to propel/repel dispensers containing one or more features in combination which provide for improved manufacture, dispenser strength and consumer use. The features of the invention include a single lead thread design for an upright member of a screw structure, a “click” feature to provide for improved sound and feel for dispensing and retracting of a product by the consumer, and a screw-retaining feature for holding the screw structure within the dispenser maintaining the strength integrity of the dispenser.

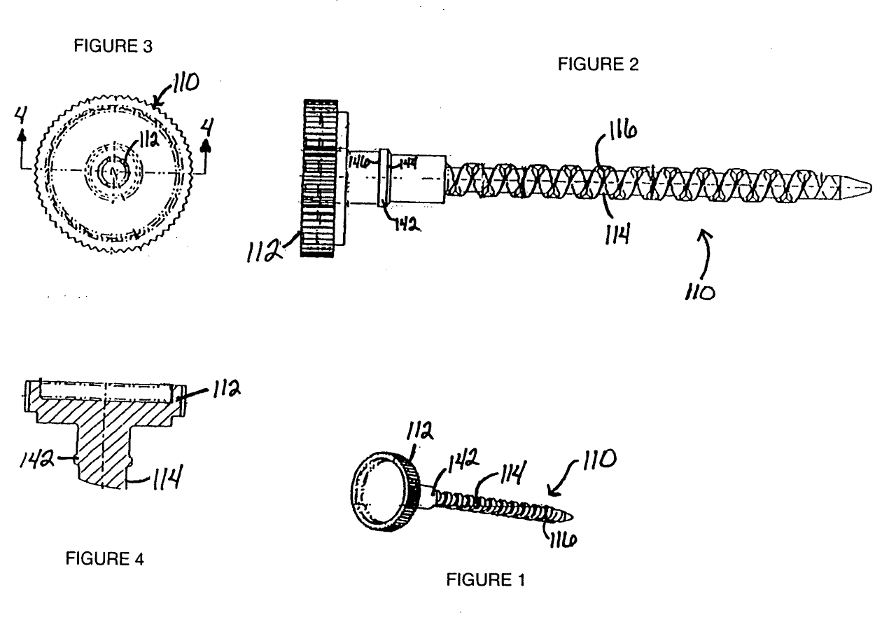

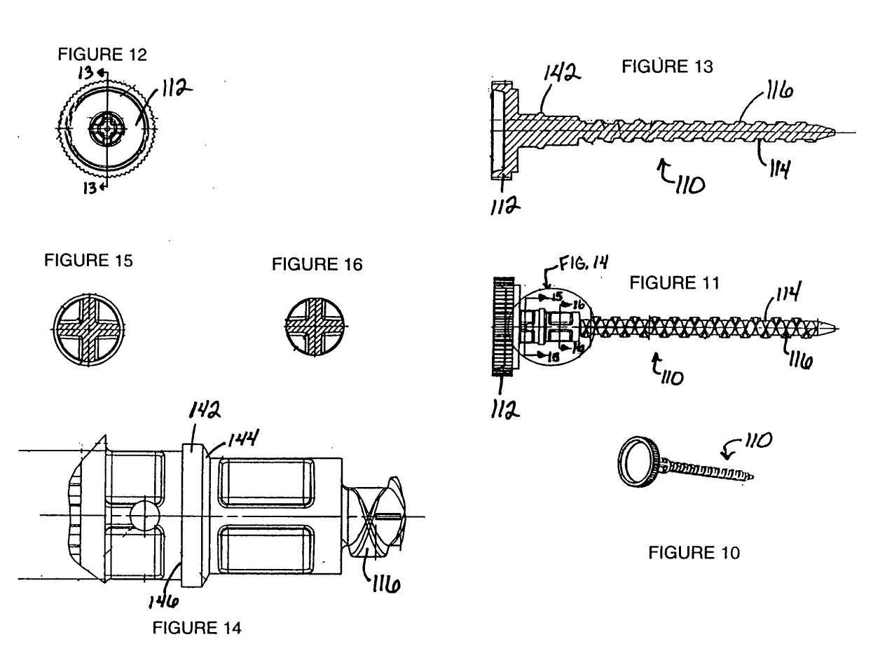

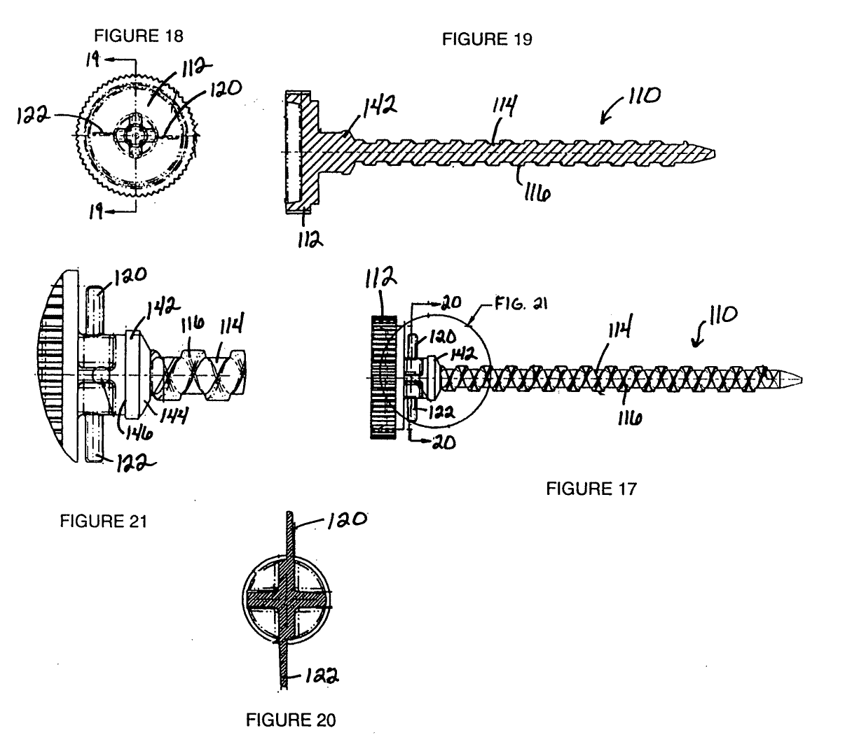

FIGS. 1-21 show four embodiments of a one piece screw structure 110 for a propel/repel dispenser 100 in accordance with the invention. The structure can be made of a thermoplastic material, preferably polypropylene. Each of the embodiments illustrated in FIGS. 1-21 include a base turn screw 112 having an upright member 114 extending lengthwise from the center of a top surface of the turn screw. The top portion of the upright member 114 essentially includes a wide single lead thread structure 116, i.e., screw thread, wherein the screw thread provides a complete revolution around the upright member 114.

The wide single lead thread 116 provides for improvement in the manufacture of the thread with regard to the molding of the structure and ease of removal from a mold. “Wide” in reference to the screw thread refers to the thread profile detail being based on evenly spacing the root and crest over the length of the screw based on the “threads per inch.” For example, a 6 threads per inch would result in a wider spaced root and crest than an 8 threads per inch, i.e., 0.075 vs. 0.055, respectively. Preferably, the wide single thread 116 has from about 4 to about 10 threads per inch, more preferably from about 5 to about 9 threads per inch and most preferably from about 6 to about 8 threads per inch. The wide single thread 116 additionally serves to allow for efficient traveling of an elevator along the thread.

The screw structure 110 also has a widened portion between the turn screw 112 and the upright member 114, in the base portion of the upright member 114. The widened portion is preferably a locking projection which aids in holding the screw structure 110 inside the body of the dispenser as described in further detail below.

The screw structure 110 is inserted into a dispenser body 126 and combined with an elevator to form the propel/repel dispenser 100 of the invention as detailed below.

The elevator as will be described below includes an internal screw thread structure which is complementary to the lead screw thread 116 on the upright member 114.

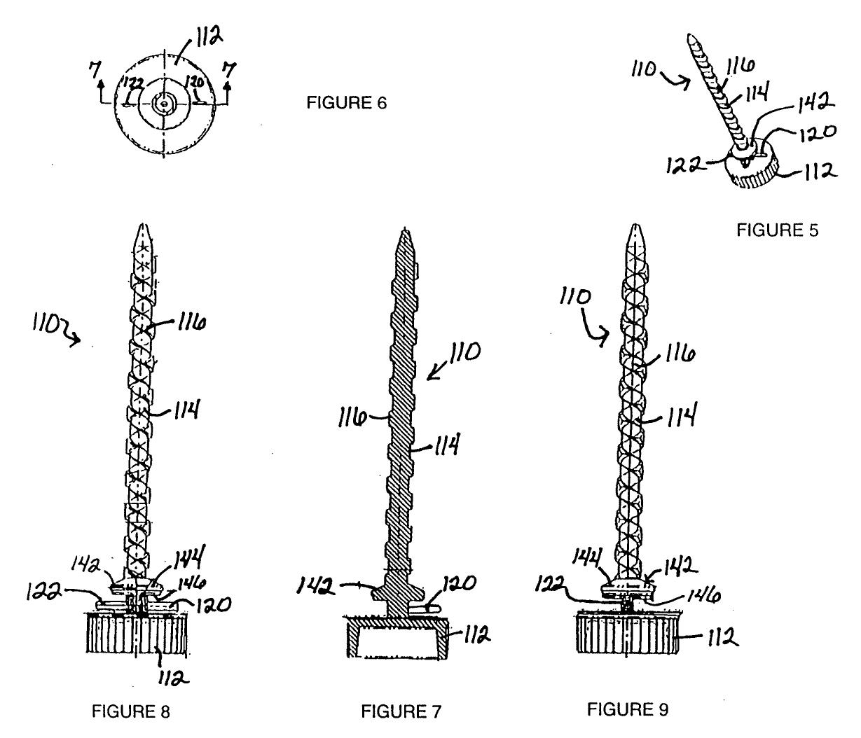

In the embodiments shown in FIGS. 5-9 and 17-21, the screw structure 110 additionally includes two flaps or extensions 120,122 projecting from a lower portion of the upright member 114 above the top of the turn screw 112, preferably between the locking projection and the turn screw 112. Two extensions are preferably present although the extensions can be present as one or more. These extensions 120,122 are a first part of the “click” feature of the invention and a plurality of ribs contained on an inner surface wall 126 on the body of the dispenser comprise a second part of the “click” feature as will be further described below.

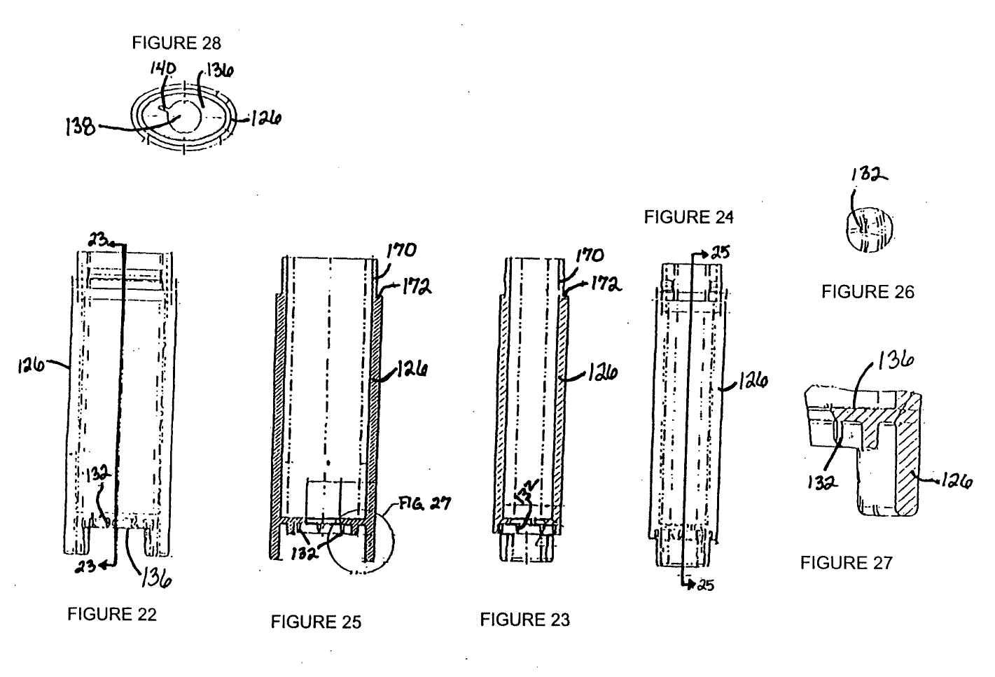

FIGS. 22-28 show the body 126 of the dispenser of the invention, including the second part of the “click” feature of the invention, i.e., the ribs 132.

FIG. 22 shows a front exterior view of the body 126 of a preferred embodiment of the dispenser having an elliptical shape and FIG. 24 shows the body 126 from a side exterior view. FIG. 23 shows a cross-section along line 23-23 of FIG. 22 and FIG. 25 shows a cross-section along line 25-25 of FIG. 24 showing the placement of a plurality of ribs 132 in the bottom portion of the body 126. FIG. 26 shows a detail of a rib 132 projecting from an interior surface wall of the body 126. FIG. 27 shows a detail within the circle portion of FIG. 25 of a rib 132 extending inward from an interior wall surface of body 126. When the screw structure 110 is inserted through an opening 138 in the bottom or base wall 136 of the body 126 as illustrated in FIG. 56, the extensions 120,122 of the screw structure 110 will be at approximately the same level or in about the same plane as the plurality of ribs 132 (see FIGS. 59 and 60 showing the dispenser assembled) due to bottom or base wall 136 being recessed in body 126 (see FIGS. 22, 56 and 59).

Accordingly, when the turn screw 112 is rotated to propel or retract product from the body of the dispenser, the extensions 120,122 on the turn screw 112 will rotate past the one or more of the plurality of ribs 132 and upon passing provide for a clicking sound and feel. A consumer, based upon the clicking will be able to control by sound and feel the amount of product propelled or retracted with greater accuracy. The ribs 132 are provided with a sufficient amount of pressure and response so as to provide feel as well as sound.

FIG. 28 shows the bottom or base wall 136 contained in the body 126 as viewed from the bottom of the body 126. The base wall 136 includes a central opening 138 having a single slot 140 extending from the opening 138. Accordingly, when the screw structure 110 is inserted through the bottom of the body 126, the screw structure 110 passes through the opening 138 in the base wall 136 into the body 126 of the dispenser. The single slot 140 provides sufficient flexibility in the base wall 136 to allow for the passing through of the widened portion of the screw structure 110 which will serve to hold the screw structure 110 in place in the body 126 once the screw structure 110 passes through the opening 138 in the base wall 136. The circumference of the widened portion of the screw structure is greater in size than the size of the opening 138 in absence of the slot 140. The single slot 140, however, also allows for the maintenance of strength and integrity to the base wall 136 of the body 126.

Conventional screw retention features generally have either a solid conical design or a multi-segmented design. The solid conical design requires added pressure upon assembly to insert the screw structure into the body and/or smaller locking structures on the screw structure in order to allow the screw structure to pass through the central opening of an unbroken base wall. A conventional multi-segmented design allows for an easier pass through of the screw structure but also results in a weaker base wall.

A locking projection of the present invention on the screw structure 110 is shown in FIGS. 1-21 in the various embodiments of the screw structure 110. In the embodiments of FIGS. 1-4 and 10-16, the locking projection is a retention means 142 which is a projection in the lower portion of the upright member 114 having an inclined face 144 to ease onset of the pass through of the screw structure 110 through the central opening 138 of the base wall 136. The inclined face is thus angled downward in relation to the upright member of the screw structure. The bottom 146 of the retention means 142 is essentially perpendicular to the upright member 114 and sits on top the base wall 136 of the body 126 once the screw structure 110 is in place in the body 126. In the embodiments of FIGS. 5-9 and 17-21, the retention means 142 is similar in structure in that the retention means 142 has an inclined upper face 144 and a flat bottom wall 146.

The embodiments of the screw structure 110 in FIGS. 5-9 and 17-21 also have extensions 120,122 as detailed above. The extensions 120,122 project from the lower portion of the upright member 114 preferably between the retention means 142 and the turn screw 112.

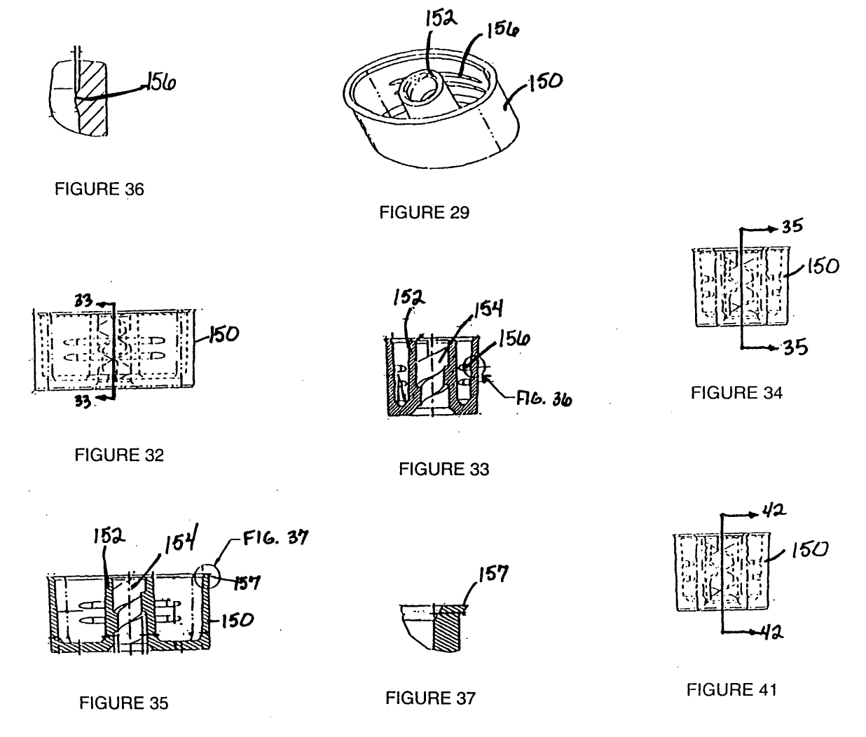

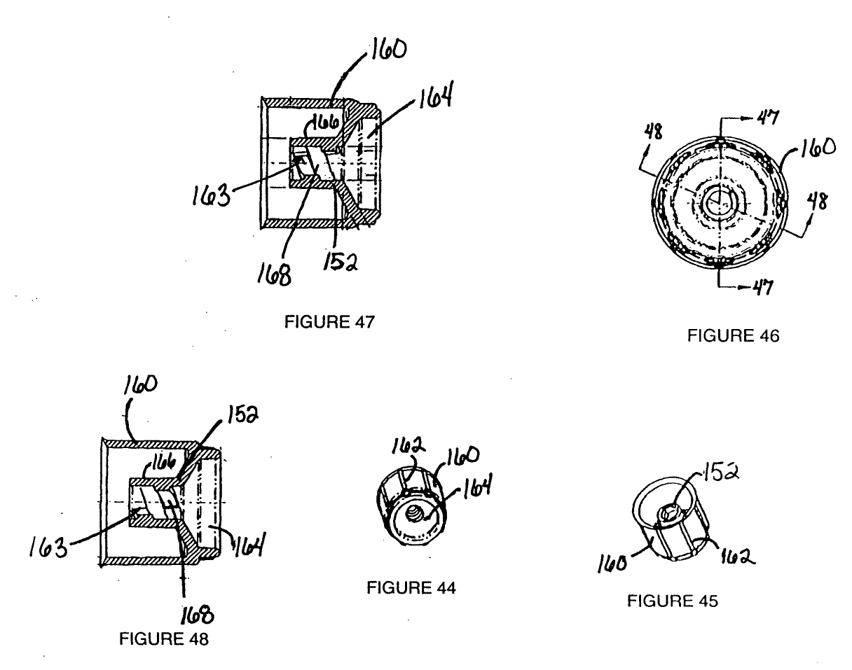

FIGS. 29-37, 39-42 and 44-54 illustrate various embodiments of the elevator of the invention useful with the screw structure 110 including the single lead thread of the invention. FIGS. 29-37 and 39-42 illustrate embodiments of an elevator suitable for use in a dispensing body having an elliptical shape. FIGS. 44-54 illustrate another embodiment of an elevator useful in a dispensing body having a round shape.

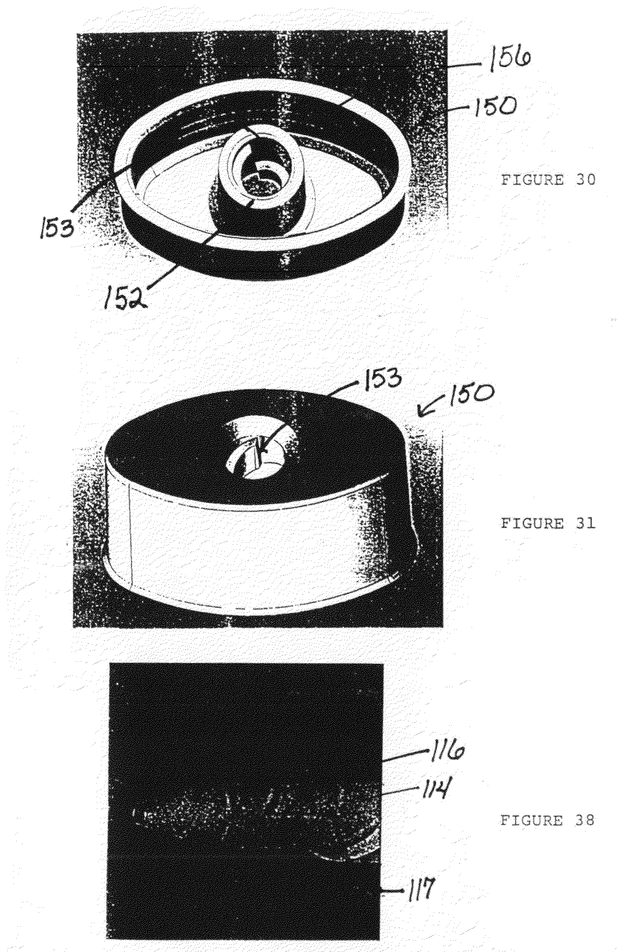

With regard to a first embodiment of the elevator, FIG. 29 shows a perspective top view of the elevator 150 having an elliptical shape and suitable for use in a dispensing body having an elliptical shape. FIG. 30 shows a top perspective view of the elevator 150 of FIG. 29. FIG. 31 shows a bottom perspective view of the first embodiment of the elevator of FIG. 29. FIG. 32 shows a front exterior view of the first embodiment of the elevator 150 of FIG. 29. FIG. 33 shows a cross-section of the first embodiment of the elevator 150 along line 33-33 of FIG. 32 showing in further detail the central portion 152 containing an internal screw thread 154 which complements and thereby is able to receive the external screw thread/single lead thread 116 of the upright member 114 of the screw structure 110. FIG. 34 shows a side exterior view of the first embodiment of the elevator 150 of FIG. 29 including dotted lines showing interior structure thereof. FIG. 35 shows a cross-section of the first embodiment of the elevator 150 along line 35-35 of FIG. 34 showing in further detail the central portion 152 containing the internal screw thread 154 which complements and is thereby able to receive the single lead thread 116 of the upright member 114 of the screw structure 110. FIG. 36 illustrates a detail of a widthwise internal projection 156 shown within the circled portion of FIG. 33. The projections 156 provide structure for holding product in place within the elevator 150 once the dispenser body 126 is filled with product. FIG. 37 shows a detail of a top edge 157 of the elevator 150 shown in the circle portion of FIG. 35. The top edge 157 preferably is angled outward to provide for a wiper seal against the interior wall of the body 126 of the dispenser in order to prevent product from going between the outside of the elevator and the inner wall of the body.

In the first embodiment of the elevator 150, the internal screw thread 154 has a leading edge 153 which is a flat straight edge, as shown for example in FIGS. 30 and 31.

Any suitable screw structure 110 having a suitable lead screw thread 116 on the upright member 114 may be used with the elevator 150 shown in FIGS. 29-37. However, a preferred screw structure 110 has a lead screw thread 116 with a leading edge 117 that is a flat straight edge, as shown for example in FIG. 38. The flat straight leading edge 117 of the lead screw thread 116 corresponds to the flat straight leading edge 153 of the internal screw thread 154 to provide engagement of the threads.

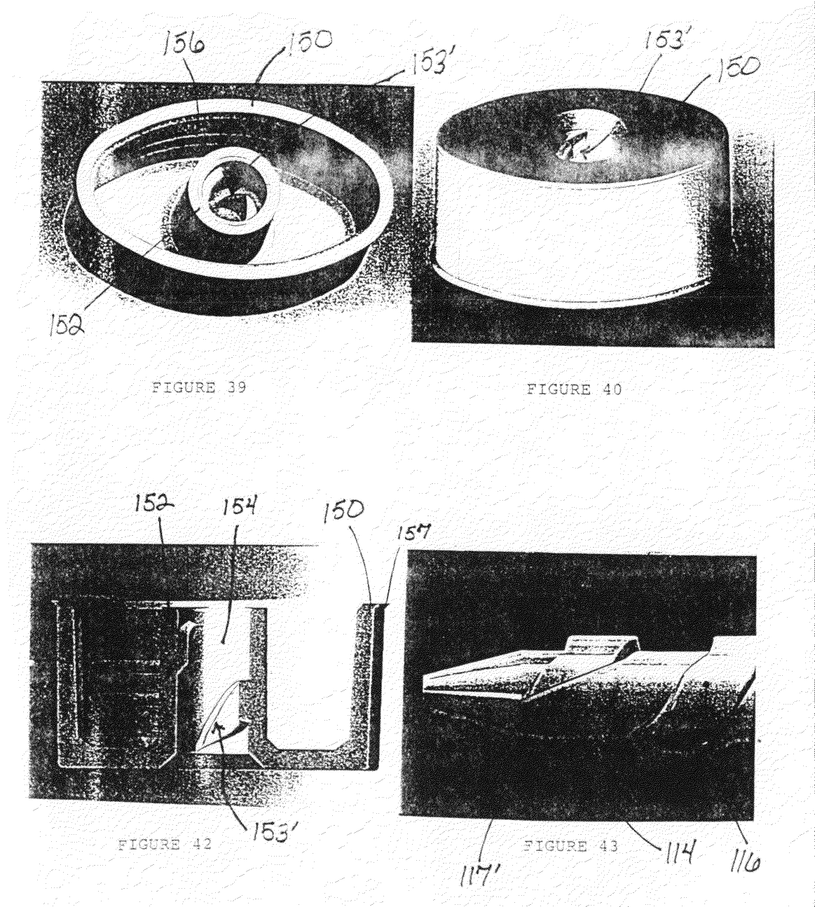

FIG. 39 shows a top perspective view of a second embodiment of the elevator 150. FIG. 40 shows a bottom perspective view of the second embodiment of the elevator 150 of FIG. 39. FIG. 41 shows a side exterior view of the second embodiment of the elevator 150 of FIG. 39 including dotted lines showing interior structure thereof. FIG. 42 shows a cross-section of the second embodiment of the elevator 150 showing in further detail the central portion 152 containing the internal screw thread 154 which complements and is thereby able to receive the single thread 116 of the upright member 114 of the screw structure 110.

In the second embodiment of the elevator 150, the internal screw thread 154 has a leading edge 153′ which is an angled edge, as shown for example in FIGS. 39, 40 and 42.

Any suitable screw structure 110 having a suitable lead screw thread 116 on the upright member 114 may be used with the elevator 150 shown in FIGS. 39-42. However, a preferred screw structure 110 has a lead screw thread 116 with a leading edge 117′ that is an angled edge, as shown for example in FIG. 43. The angled leading edge 117′ of the lead screw thread 116 corresponds to the angled edge 153′ of the internal screw thread 154 to provide engagement of the threads. Also, the angled leading edges 117′,153′ improve the initial engagement of both threads.

The embodiments of the elevator 150 as shown in FIGS. 39-42 also preferably comprise at least one widthwise internal projection 156 to provide for structure for holding the product in place within the elevator 150 once the dispenser body 126 is filled with product.

FIG. 44 shows a perspective bottom view of an embodiment of an elevator 160 useful in a dispensing body having a round shape. FIG. 45 shows a perspective top view of the elevator 160 of FIG. 44. FIG. 46 shows a bottom view of the elevator 160 of FIG. 44. FIG. 47 shows a cross-section of the elevator 160 along line 47-47 of FIG. 46 showing in further detail the central portion containing an internal screw thread 168. FIG. 48 shows a cross-section of the elevator 160 along line 48-48 of FIG. 46 showing in further detail the central portion containing the internal screw thread 168. In this embodiment, the elevator 160 has a central opening 164 leading to a passage 166 containing internal screw thread complementary to the external screw thread 116 of the upright member 114. The internal screw thread 168 has a leading edge 163 which is a flat straight edge as described above. Alternatively, the leading edge can be angled as described above in relation to the embodiment of FIGS. 42 and 43.

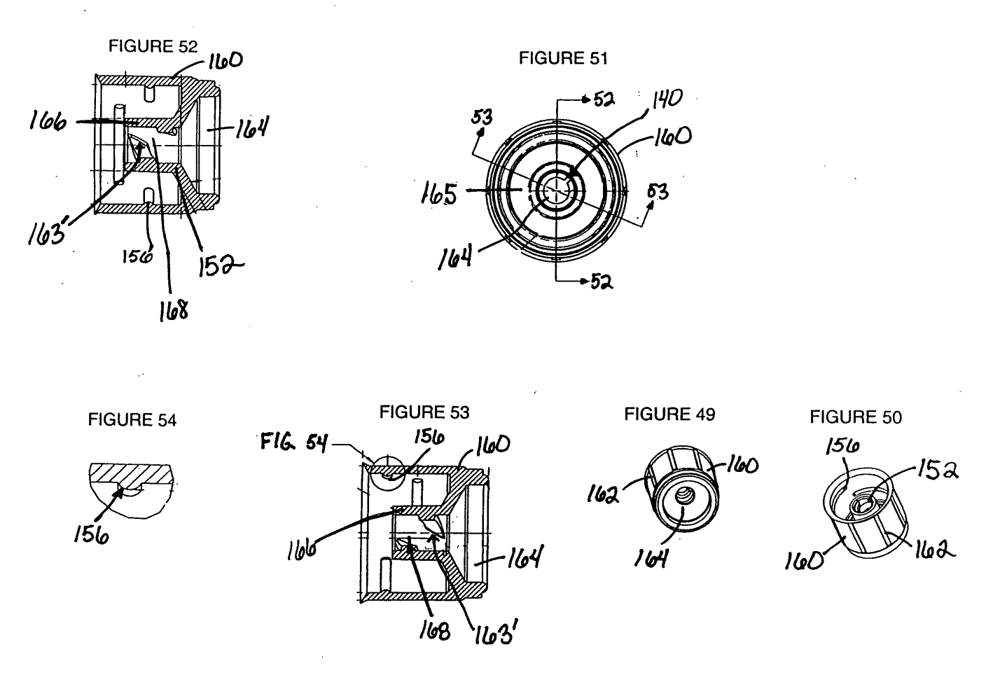

FIG. 49 shows a perspective bottom view of another embodiment of an elevator 160 having a round shape. FIG. 50 shows a perspective top view of the elevator 160 of FIG. 49. FIG. 51 shows a bottom view of the elevator 160 of FIG. 49. FIG. 52 shows a cross-section of the elevator 160 along line 52-52 of FIG. 51 showing in further detail the central portion 152 containing an internal screw thread 168. FIG. 53 shows a cross-section of the elevator 160 along line 53-53 of FIG. 51 showing in further detail the central portion 152 containing an internal screw thread 168. FIG. 54 shows a detail of a widthwise internal projection 156 shown within the circled portion of FIG. 53. The projections 156 provide for holding the product in place within the elevator 160 once the dispenser is filled with product.

In this embodiment, the elevator 160 has a central opening 164 leading to a passage 166 containing internal screw threads 168 complementary to the external screw threads 116 of the upright member 114. The internal screw 168 has a leading edge 163′ which is preferably an angled leading edge as described above.

The central opening 164 in the base of the elevator 160 has a single slot 140 extending from the opening 164. This slot configuration provides sufficient flexibility in the base wall 165 of the elevator to allow for mating of the widened portion of the screw structure 110 which will serve to hold the screw structure 110 in relation to the elevator once the screw structure 110 passes through the opening 138 of the base wall 136 as described above.

The embodiments of the elevator 150 can have smooth exterior side walls as shown in FIGS. 29-37 and 39-42 or the elevator 160 as shown for example in FIGS. 44-54 can have a plurality of ribs 162 along the side wall. In the embodiment of FIGS. 29-37 and 39-42, no ribs are required due to the shape, i.e., elliptical shape, of the elevator 150 and the dispenser body. Upon rotation of the turn screw to propel or repel product, the elevator 150 is incapable of rotating within the body and thus travels along the upright member 114 of the screw structure 110.

In the embodiment of FIGS. 44-54, ribs 162 are present on the exterior wall of the elevator 160 and additional ribs are preferably present on the inner side wall of the dispenser to prevent the elevator 160 from spinning within the body of the dispenser upon rotation of the turn screw 112.

As shown by the different embodiments of FIGS. 29-37, 39-42 and 44-54, the internal screw thread portion of the elevator can pass through the entire length of the elevator as shown in the embodiments of FIGS. 29-37 and 39-42, or extend through only a portion of the length of the elevator as shown in the embodiments of FIGS. 44-54.

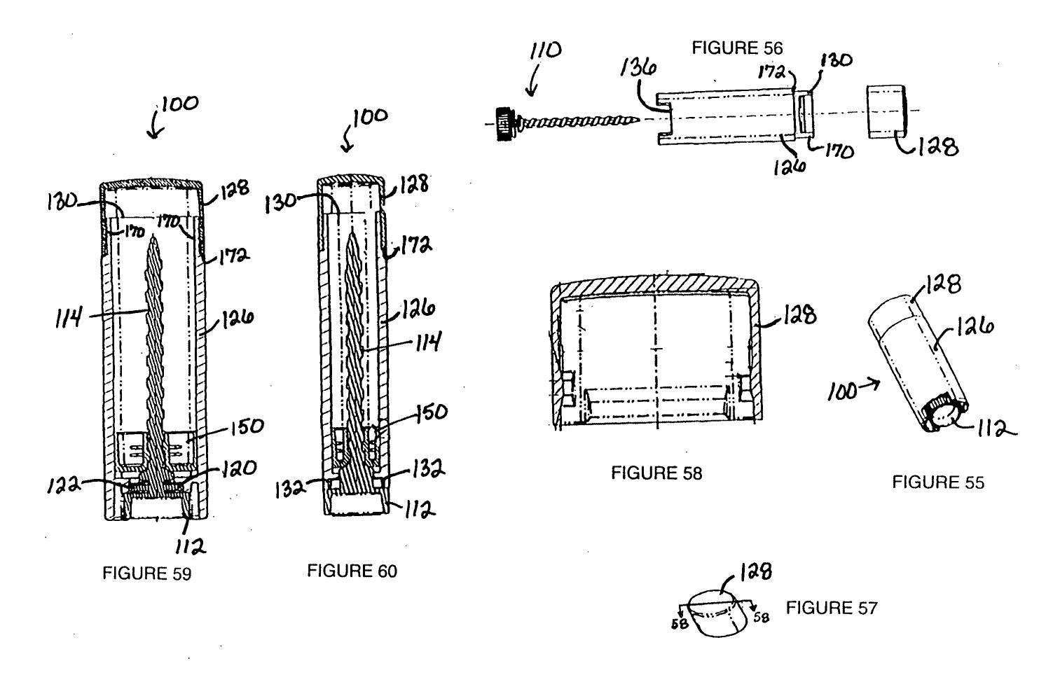

FIGS. 55 and 56 show an example of a dispenser 100 of the invention. In FIGS. 55 and 56, and other figures herein, the body 126 of the dispenser 100 is shown as having an elliptical shape. Necessarily the body can be of other shapes, such as a conventional round body. FIG. 55 is a perspective view of an assembled dispenser 100 having a screw structure inserted therein and showing the placement of the turn screw 112 therein upon assembly. A cap 128 is present on the top open end 130 of the body 126. FIG. 56 illustrates the direction of assembly between the screw structure 110, dispensing body 126 and cap 128. The dispensing body 126 preferably includes an inset top wall portion 170 with a shoulder 172 for receiving a cap 128 thereon so that side walls of the cap provide for a unitary smooth exterior surface. The elevator is not shown in FIG. 56.

When the screw structure 110 is inserted into the bottom of the body 126 as illustrated in FIG. 56, the extensions of the screw structure 110 will be at approximately the same level or in about the same plane as the plurality of ribs 132 (see FIGS. 59 and 60 showing the dispenser assembled).

FIGS. 57 and 58 illustrate a cap 128 suitable for use with respect to the embodiment of the invention utilizing a elliptically shaped dispenser body. Necessarily when a differently shaped body is utilized, a different shaped cap will be utilized.

FIGS. 59 and 60 show a cross-sectional view from the front and from the side, respectively, of a dispenser 100 of the invention in assembled form. The dispenser 100 includes the body 126 having a cap 128 thereof, and a screw structure 110 inserted through the base of the body 126. An elevator 150 is positioned on the upright member 114 of the screw structure 110. The dispensing body 126 includes, preferably, an inset top wall portion 170 with a shoulder 172 for receiving the cap 128 thereon so that the side walls of the cap provide for a unitary smooth exterior surface. However, any suitable cap may be used and the top portion of the dispenser may be configured for receiving the cap. FIG. 59 also shows two extensions 120,122 in the lower portion of the screw structure 110 above the turn screw 112. FIG. 60 also shows ribs 132 on the interior wall of the body 126 with which the extensions 120,122 interact to provide the “click” feature of the invention.

Each part of the dispenser 100 of the invention is preferably made of a thermoplastic material, most preferably polypropylene. However, any suitable material may be used.

As will be apparent to one skilled in the art, various modifications can be made within the scope of the aforesaid description. Such modifications being within the ability of one skilled in the art form a part of the present invention and are embraced by the appended claims.

1. A one piece screw structure for a propel/repel dispenser comprising a turn screw portion having an upright member extending from a center area of a top surface of the turn screw, said upright member having extending lengthwise over a major portion thereof a single lead thread extending circumferentially around the upright member, said single lead thread having a thread profile with crest and root which are evenly spaced over a length of the upright member and the single lead thread having a width which provides from about 4 to about 10 threads per inch.

2. The one piece screw structure of claim 1, wherein said single lead thread has a leading edge which is a flat straight edge.

3. The one piece screw structure of claim 1, wherein said single lead thread has a leading edge which is an angled edge.

4. The one piece screw structure of claim 1, wherein said single lead thread has from about 5 to about 9 threads per inch.

5. The one piece screw structure of claim 1, wherein said single lead thread has from about 6 to about 8 threads per inch.

6. The one piece screw structure of claim 1, further comprising a retaining portion, wherein said retaining portion is present on a lower portion of the upright member and said retaining portion has an angled top surface which is angled downward in relation to said upright member and a bottom surface which is substantially perpendicular to the upright member.

7-34. (canceled)
